(19) United States
(12) Patent Application Publication
(10) Pub. No.: US 2024/0244053 A1
(43) Pub. Date: Jul. 18, 2024

(54) PACKET CAPTURE IN A CONTAINER ORCHESTRATION SYSTEM

(71) Applicant: VMware, Inc., Palo Alto, CA (US)

(72) Inventors: Quan TIAN, Beijing (CN); Wenfeng LIU, Beijing (CN); Jianjun SHEN, Redwood City, CA (US); Donghai HAN, Beijing (CN)

(21) Appl. No.: 18/185,746

(22) Filed: Mar. 17, 2023

(30) Foreign Application Priority Data
Jan. 18, 2023 (WO) PCT/CN2023/000016

(51) Int. Cl. H04L 9/40

(52) U.S. Cl. CPC H04L 63/0892; H04L 63/0245

(57) ABSTRACT

An example method of packet capture in a container orchestration (CO) system includes: receiving, from a user interface executing on a client device, a packet capture request from a user at a packet capture agent executing in a node of the CO system; authenticating and authorizing, by the packet capture agent in cooperation with an application programming interface (API) server executing in a master server of the CO system, the user specified in the packet capture request; capturing, by the packet capture agent, packets from at least one network interface based on the packet capture request; and returning information based on the packets as captured from the packet capture agent to the user interface.

### CROSS-REFERENCE

This application is based upon and claims the benefit of priority from International Patent Application No. PCT/CN2023/000016, filed on Jan. 18, 2023, the entire contents of which are incorporated herein by reference.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtual infrastructure is carried out by management software that communicates with virtualization software (e.g., hypervisor) installed in the host computers. SDDC users move through various business cycles, requiring them to expand and contract SDDC resources to meet business needs. This leads users to employ multi-cloud solutions, such as typical hybrid cloud solutions where the SDDC spans across an on-premises data center and a public cloud.

In an SDDC, applications today are deployed onto a combination of virtual machines (VMs), containers, application services, and more. For deploying such applications, a container orchestration platform known as Kubernetes® has gained in popularity among application developers. Kubernetes provides a platform for automating deployment, scaling, and operations of application containers across clusters of hosts. It offers flexibility in application development and offers several useful tools for scaling.

Packet capture in an SDDC is a vital tool used to analyze network problems, debug network protocol implementations, and troubleshoot performance problems. However, it can be challenging to capture packets that pass over a container workload in a Kubernetes cluster. First, the mapping from the container workload to the network device must be known. This is not a trivial task since Kubernetes delegates workload networking to a container network plugin (CNI) that implements standard a CNI application programming interface (API) but configures networking for each workload in the plugin's own way. The network device may be a veth device, macvlan device, or an OVS internal port, etc. In addition, network plugins may name network devices differently. Second, the permission to login to the node that runs the container workload and to perform packet capture must be granted. In practice, such permission is usually granted at the granularity of the node, which means a user can either be granted to capture packets of all workloads on a node or none of the workloads on a node. Kubernetes uses namespaces instead of nodes as the mechanism for isolating resources. Further, the permission usually comes with other system permissions of the node, which may break the principle of least privilege.

### SUMMARY

In embodiments, a method of packet capture in a container orchestration (CO) system includes: receiving, from a user interface executing on a client device, a packet capture request from a user at a packet capture agent executing in a node of the CO system; authenticating and authorizing, by the packet capture agent in cooperation with an application programming interface (API) server executing in a master server of the CO system, the user specified in the packet capture request; capturing, by the packet capture agent, packets from at least one network interface based on the packet capture request; and returning information based on the packets as captured from the packet capture agent to the user interface.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a container orchestration (CO) system according to embodiments.

FIG. 2 is a block diagram of an SDDC in which embodiments described herein may be implemented.

FIG. 3 is block diagram depicting another embodiment of a CO system in which the packet capture techniques described in FIG. 1 can be used.

FIG. 4 is a flow diagram depicting a method of packet capture in a CO system according to embodiments.

### DETAILED DESCRIPTION

Packet capture in a container orchestration system is described. In embodiments, packet capture is a tool used to analyze network problems, debug network protocol implementations, troubleshoot performance problems, and the like. It can be challenging to capture packets that pass over a container workload in a container orchestration cluster as discussed above. In embodiments, a packet capture technique is described that can capture packets to/from container workloads. The techniques provide a way for a user to remotely perform packet capture for any container workload and for any network device of nodes in the cluster without the need of knowing how the workloads are distributed and which network devices the workloads use. A packet capture agent executes in the node and receives packet capture requests initiated by the user. The packet capture agent cooperates with an API server of the container orchestration system to authenticate and authorize the user of the packet capture request. The packet capture agent then captures packets from network interface(s) based on the request. The packet capture agent returns information based on the packets as capture to the user interface. These and further embodiments are described below with respect to the drawings.

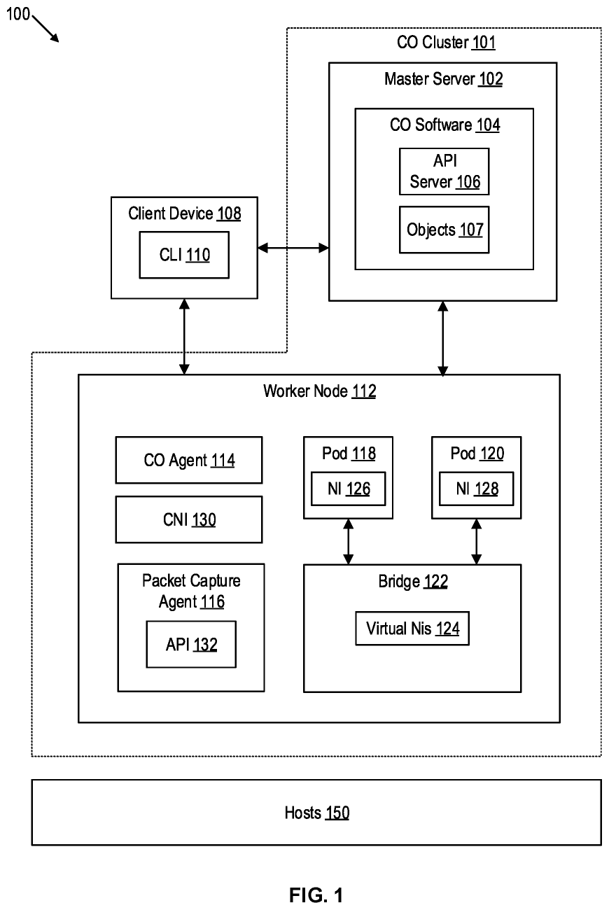

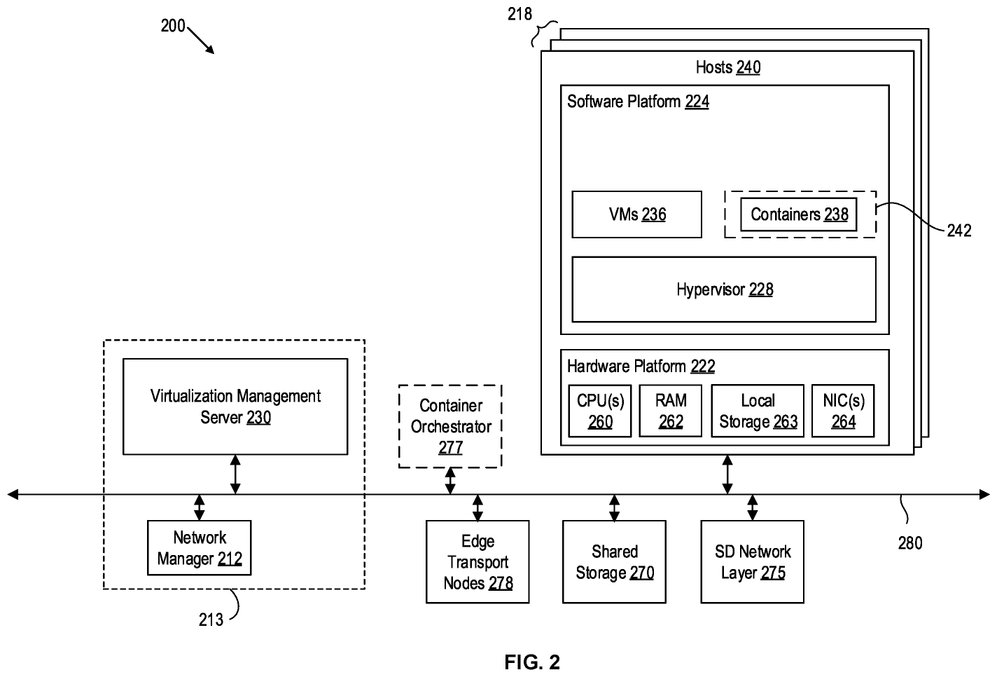

FIG. 1 is a block diagram depicting a container orchestration (CO) system 100 according to embodiments. CO system 100 includes a CO cluster 101 having a master server 102 and a worker node 112 executing on host computers (hosts) 150. Although only a single master server 102 is shown, CO system 100 can include multiple instances of master server 102. Although only a single worker node 112 is shown, CO system 100 can include a plurality of worker nodes. Hosts 150 include processors, memory, storage, network devices, and the like. Example hosts are shown in FIG. 2.

Master server 102 executes CO software 104 that includes an application programming interface (API) server 106. For example, CO software 104 can be Kubernetes control plane software and API server 106 can be kube-apiserver. Master server 102 can execute on a host 150 (e.g., directly on host hardware managed by a host operating system (OS) or in a virtual machine (VM) managed by a hypervisor). API server 106 manages objects 107, which can include pods, nodes, namespaces, and the like CO constructs (e.g., Kubernetes objects).

Worker node 112 executes on a host 150 (e.g., directly on host hardware managed by a host operating system (OS) or in a virtual machine (VM) managed by a hypervisor). Worker node 112 includes a CO agent 114, a container network interface (CNI) 130, a packet capture agent 116, a bridge 122, and pods 118 and 120. Although two pods 118 and 120 are shown in the example, worker node 112 can include at least one pod. Pods 118 and 120 execute containers per their pod specifications (container workloads). CO agent 114 operates as an agent of CO software 104 in master server 102. For example, in a Kubernetes implementation, CO agent 114 is a kubelet. CO agent 114 accepts pod specifications from master server 102 and ensures that pods described in those pod specifications are running on node (e.g., pod 118 and pod 120). CO agent 114 issues CNI commands to CNI 130 to setup networking for pods 118 and 120. CNI 130 facilitates deployment of bridge 122 and pairs of virtual network interfaces between each pod and bridge 122. Bridge 122 comprises a virtual network switch and includes virtual network interfaces (Nis) 124. Pod 118 includes a NI 126 and pod 120 includes an NI 128. Example virtual network interfaces include veth, macvlan, and the like. Packet capture agent 116 includes an API 132 and functions as described below.

CO system 100 includes a client device 108. Client device 108 can be a host 150 or some other device external to CO cluster 101. Client device 108 executes a command line interface (CLI) 110. Although a CLI 110 is described by way of example, those skilled in the art appreciate that any user interface (UI) can be utilized, such as a graphical user interface (GUI).

In embodiments, CO system 100 allows a user to perform packet capture for any container workload and any network device of nodes in CO cluster 101 without having to know how workloads are distributed and which network devices the workloads utilize. CO system 100 also provides an authorization mechanism with which the packet capture permission can be granted at the granularity of a pod or node.

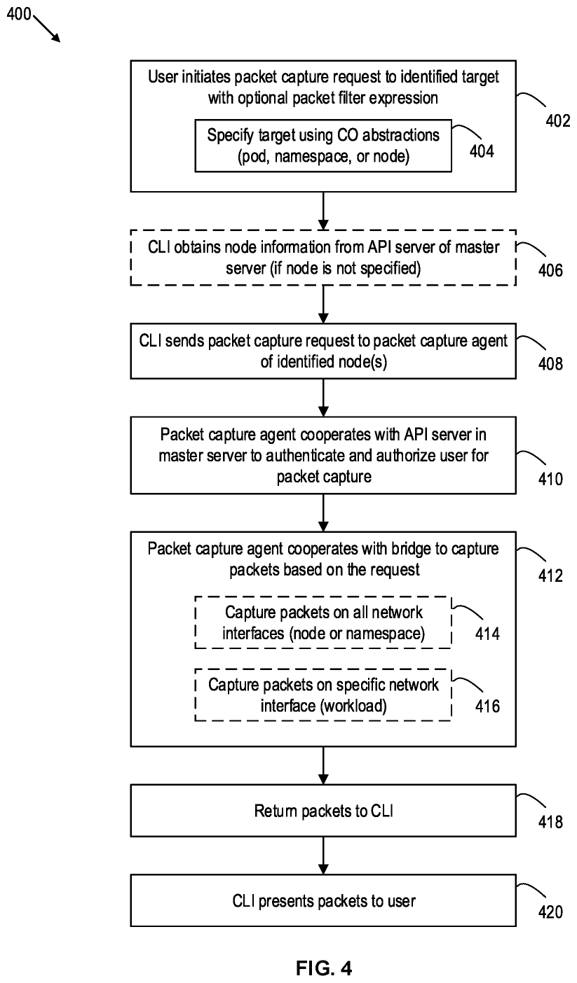

In embodiments, a user interacts with CLI 110 executing on client device 108 to initiate a packet capture operation. The user can specify the target of the packet capture using CO abstractions (e.g., pod, namespace, node). The user can also specify an optional packet filter expression (e.g., protocol, port, etc.). CLI 110 can optionally interact with API server 106 to obtain node information if the user has specified non-node objects (e.g., pods, namespace). CLI 110 then interacts with packet capture agent 116 through its API 132 on the target node (e.g., worker node 112). Packet capture agent 116 interacts with API server 106 to authenticate and authorize the user for the packet capture operation. Once authenticated and authorized, packet capture agent 116 interacts with bridge 122 to capture packets on target virtual NIs 124 depending on the request (e.g., a specific NI if a pod is specified or all Nis if a node is specified). Packet capture agent 116 then returns the captured packets to CLI 110. CLI 110 presents the capture packets to the user. Further details of the packet capture process are described below with respect to FIG. 4.

FIG. 2 is a block diagram of an SDDC 200 in which embodiments described herein may be implemented. SDDC 200 includes a cluster of hosts 240 (“host cluster 218”) that may be constructed on hardware platforms such as an x86 architecture platforms. For purposes of clarity, only one host cluster 218 is shown. However, SDDC 200 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240 (other components discussed further herein).

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN (vSAN), which is another form of shared storage 270.

A software platform 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed.

Host cluster 218 is configured with a software-defined (SD) network layer 275. SD network layer 275 includes logical network services executing on virtualized infrastructure in host cluster 218. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical Joad balancers, and the like, implemented on top of the virtualized infrastructure. In embodiments, SDDC 200 includes edge transport nodes 278 that provide an interface of host cluster 218 to a wide area network (WAN) (e.g., a corporate network, the public Internet, etc.).

Virtualization management server 230 is a physical or virtual server that manages host cluster 218 and the virtualization layer therein. Virtualization management server 230 installs agent(s) in hypervisor 228 to add a host 240 as a managed entity. Virtualization management server 230 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. Virtualization management server 230 can manage more than one host cluster 218.

In an embodiment, SDDC 200 further includes a network manager 212. Network manager 212 is a physical or virtual server that orchestrates SD network layer 275. In an embodiment, network manager 212 comprises one or more virtual servers deployed as VMs. Network manager 212 installs additional agents in hypervisor 228 to add a host 240 as a managed entity, referred to as a transport node. In this manner, host cluster 218 can be a cluster of transport nodes. One example of an SD networking platform that can be configured and used in embodiments described herein as network manager 212 and SD network layer 275 is a VMware NSX® platform made commercially available by VMware, Inc. of Palo Alto, CA.

Virtualization management server 230 and network manager 212 comprise a virtual infrastructure (VI) control plane 213 of SDDC 200. VIM server appliance 230 can include various VI services. The VI services include various virtualization management services, such as a distributed resource scheduler (DRS), high-availability (HA) service, single sign-on (SSO) service, virtualization management daemon, and the like. An SSO service, for example, can include a security token service, administration server, directory service, identity management service, and the like configured to implement an SSO platform for authenticating users.

In embodiments. SDDC 200 can include a container orchestrator 277. Container orchestrator 277 implements an orchestration control plane, such as Kubernetes®, to deploy and manage applications or services thereof on host cluster 218 using containers 238. In embodiments, hypervisor 228 can support containers 238 executing directly thereon. In other embodiments, containers 238 are deployed in VMs 236 or in specialized VMs referred to as “pod VMs 242.” A pod VM 242 is a VM that includes a kernel and container engine that supports execution of containers, as well as an agent (referred to as a pod VM agent) that cooperates with a controller executing in hypervisor 228 (referred to as a pod VM controller). Container orchestrator 277 can include one or more master servers configured to command and configure pod VM controllers in host cluster 218. Master server(s) can be physical computers attached to network 280 or VMs 236 in host cluster 218.

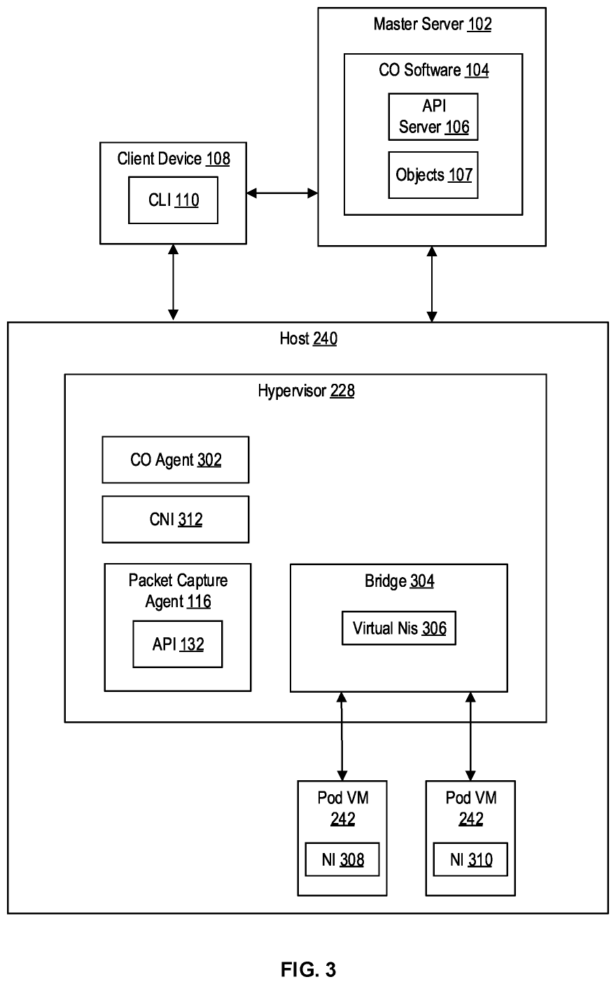

FIG. 3 is block diagram depicting another embodiment of a CO system in which the packet capture techniques described in FIG. 1 can be used. In the embodiment of FIG. 3, a host 240 executes hypervisor 228. Hypervisor 228 includes a CO agent 302 and a CNI 312. CO agent 302 functions similarly to CO agent 114 except that pods are deployed in pod VMs 242. CO agent 302 can use CNI 312 to deploy a bridge 304, which comprises a virtual switch. Bridge 304 includes virtual NIs 306. Pod VMs 242 include NIs 308 and 310 (e.g., two pod VMs 242 are shown in the example, but any number of pod VMs can be deployed). Packet capture can proceed as described above, with CLI 110 communicating with packet capture agent 116 executing in hypervisor 228.

FIG. 4 is a flow diagram depicting a method 400 of packet capture in a CO system according to embodiments. Method 400 begins at step 402, where a user initiates a packet capture request to an identified target with an optional packet filter expression. The user interacts with CLI 110 as described above. Example commands are described below where pktctl is an example command for capturing packets:
#A command to capture packets passing over Pod “nginx-76765d9995-rp5kr” in “default” namespace and matching TCP protocol and port 80
pktctl -pod nginx-76765d9995-rp5kr -namepsace default tcp and port 80
#A command to capture packets passing over tunnel device (genev_sys_6081) of a node worker1 and matching UDP protocol
pktctl -node worker1 -i genev_sys_6081 udp

At step 404, the user can specify the target using various CO abstractions as described in the examples above (e.g., pod, node, namespace, etc.). At optional step 406, CLI 110 obtains node information from API server 106 if the user specified non-node CO abstractions (e.g., pod, namespace). CLI 110 can query API server 106 for the node that executes a given pod, for example. If the user specified a specific node in the packet capture request, then step 406 can be skipped.

At step 408, CLI 110 sends the packet capture request to packet capture agent 116 of identified node(s). At step 410, packet capture agent 116 cooperates with API server 106 to authenticate and authorize the user for packet capture. In embodiments, packet capture agent 116 leverages role-based access control (RBAC) authorization implemented by API server 106. Examples are described below:

```
# Users bound with this role are able to capture packets of all pods
in “default” namespace
apiVersion: rbac.authorization.k8s.io/vi
kind: Role
metadata:
    namespace: default
    name: pod-packet-capturer
rules:
  - apiGroups: [“”]
  resources: [“pods”]
  verbs: [“packetcapture”]
```

```
# Users bound with this role are able to capture packets of two nodes:
worker1 and worker 2
apiVersion: rbac.authorization.k8s.io/vi
kind: ClusterRole
metadata:
  name: node-packet-capturer
rules:
  - apiGroups:[“”]
  resources: [“nodes”]
  resourceNames: [“worker1”, “worker2”]
  verbs: [“packetcapture”]
```

At step 412, packet capture agent 116 cooperates with bridge 122 (or bridge 304) to capture packets based on the request (if authenticated and authorized). Packets are captured from network interface(s) depending on the specified target. For example, at step 414, packet capture agent 116 captures packets on all network interfaces (if a node or namespace is specified). Or at step 416, packet capture agent 116 captures packets on a specific network interface (e.g., if a pod is specified).

At step 418, packet capture agent 116 returns the packets to CLI 110. At step 420, CLI 110 presents the capture packets to the user. For example:
#pktctl packetcapture -pod nginx-76765d9995-rp5kr -namespace default icmp
15:44:14.094330 IP 10.244.0.1>10.244.0.4: ICMP echo request, id 14, seq 1, length 64
15:44:14.094388 IP 10.244.0.4>10.244.0.1: ICMP echo reply, id 14, seq 1, length 64
15:44:15.092914 IP 10.244.0.1>10.244.0.4: ICMP echo request, id 14, seq 2, length 64
15:44:15.092953 IP 10.244.0.4>10.244.0.1: ICMP echo reply, id 14, seq 2, length 64

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of packet capture in a container orchestration (CO) system, comprising:
receiving, from a user interface executing on a client device, a packet capture request from a user at a packet capture agent executing in a node of the CO system;
authenticating and authorizing, by the packet capture agent in cooperation with an application programming interface (API) server executing in a master server of the CO system, the user specified in the packet capture request;
capturing, by the packet capture agent, packets from at least one network interface based on the packet capture request; and
returning information based on the packets as captured from the packet capture agent to the user interface.

2. The method of claim 1, further comprising:
presenting, by the user interface, the information to the user.

3. The method of claim 1, wherein the packet capture request specifies a pod or a namespace, and wherein the method further comprises:
obtaining, by the user interface, a node corresponding to the pod or namespace from the API server.

4. The method of claim 1, wherein the step of capturing comprises:
capturing packets from a plurality of network interfaces of the virtual switch.

5. The method of claim 1, wherein the step of capturing comprises:
identifying a network interface of the virtual switch associated with a pod specified in the packet capture request;
capturing packets from the identified network interface.

6. The method of claim 1, wherein the node comprises a host and wherein the packet capture agent executes in a hypervisor executing on the host.

7. The method of claim 6, wherein the virtual switch executes in the hypervisor and includes virtual network interfaces for pod virtual machines (VMs).

8. A non-transitory computer readable medium comprising instructions to be executed in a computing device to cause the computing device to carry out a method of packet capture in a container orchestration (CO) system, comprising:
receiving, from a user interface executing on a client device, a packet capture request from a user at a packet capture agent executing in a node of the CO system;
authenticating and authorizing, by the packet capture agent in cooperation with an application programming interface (API) server executing in a master server of the CO system, the user specified in the packet capture request;
capturing, by the packet capture agent, packets from at least one network interface based on the packet capture request; and
returning information based on the packets as captured from the packet capture agent to the user interface.

9. The non-transitory computer readable medium of claim 8, further comprising:
presenting, by the user interface, the information to the user.

10. The non-transitory computer readable medium of claim 8, wherein the packet capture request specifies a pod or a namespace, and wherein the method further comprises:
obtaining, by the user interface, a node corresponding to the pod or namespace from the API server.

11. The non-transitory computer readable medium of claim 8, wherein the step of capturing comprises:
capturing packets from a plurality of network interfaces of the virtual switch.

12. The non-transitory computer readable medium of claim 8, wherein the step of capturing comprises:
identifying a network interface of the virtual switch associated with a pod specified in the packet capture request;
capturing packets from the identified network interface.

13. The non-transitory computer readable medium of claim 8, wherein the node comprises a host and wherein the packet capture agent executes in a hypervisor executing on the host.

14. The non-transitory computer readable medium of claim 13, wherein the virtual switch executes in the hypervisor and includes virtual network interfaces for pod virtual machines (VMs).

15. A container orchestration (CO) system, comprising:
a master server executing an application programming interface (API) server;
a client executing a user interface (UI);
a worker node executing a packet capture agent, a virtual switch, and at least one pod;
wherein the UI is configured to receive a packet capture request from a user and send the packet capture request to the packet capture agent based on target specified in the packet capture request;
wherein the packet capture agent is configured to authenticate and authorize, in cooperation with the API server, the user specified in the packet capture request; capture packets from at least one network interface based on the packet capture request; and return information based on the packets as captured from the packet capture agent to the UI.

16. The CO system of claim 15, wherein the UI is configured to present the information to the user.

17. The CO system of claim 15, wherein the packet capture request specifies a pod or a namespace, and the UI is configured to obtain a node corresponding to the pod or namespace from the API server.

18. The CO system of claim 15, wherein the packet capture agent is configured to capture packets from a plurality of network interfaces of the virtual switch.

19. The CO system of claim 15, wherein the packet capture agent is configured to identify a network interface of the virtual switch associated with a pod specified in the packet capture request; and capture packets from the identified network interface.

20. The CO system of claim 15, wherein the node comprises a host and wherein the packet capture agent executes in a hypervisor executing on the host.
